(19) United States
(12) Patent Application Publication
(10) Pub. No.: US 2015/0324925 A1
(43) Pub. Date: Nov. 12, 2015

(54) Method and System for Guaranteeing Return on Funds Rolled Over into Qualified Plan

(71) Applicant: Brian Michael Fancher, Baldwinsville, NY (US)

(72) Inventor: Brian Michael Fancher, Baldwinsville, NY (US)

(21) Appl. No.: 14/704,946

(22) Filed: May 5, 2015

Related U.S. Application Data
(60) Provisional application No. 61/996,566, filed on May 12, 2014.

(51) Int. Cl. G06Q 40/08; G06Q 20/10

(52) U.S. Cl. CPC G06Q 40/08; G06Q 20/10

(57) ABSTRACT

The invention is a method and a system for guaranteeing a specified return on funds transferred, or rolled over into, a qualified plan for a specified period of time by paying out the differential between the participant's calculated actual return over the specified term and the specified guaranteed return. The specified guaranteed return is generally tied to a financial index (ex. S&P 500). This method provides participants in a qualified retirement plan, such as a 401(k) or other individual retirement account (IRA), with the necessary time to analyze the investment offerings in the qualified plan or IRA the funds are rolled into. The specified term is generally short, ranging from 30 days to 1 year, but is not limited to this time frame.

### CROSS-REFERENCE TO RELATED APPLICATIONS

Application Number: U.S. 61/996,566

Filing Date: May 12, 2014

### FIELD OF INVENTION

The invention generally pertains to guaranteeing a specified return on funds rolled into a qualified retirement plan, for example 401(k) or individual retirement account (IRA).

### BACKGROUND OF THE INVENTION

The transfer of funds between qualified retirement plans or IRAs, referred to as a rollover, is common when an individual moves employers or retires from employment. However, the decisions related to how to allocate the transferred, or rolled over, funds can be difficult as investment offerings do not match up exactly between plans, which leaves the investor who is considering rolling over funds from one plan into another plan confused and frustrated when mapping their investments from one plan to another. In addition, investors become overwhelmed by the need to research several new investment options in a short period of time in order to minimize the time the funds are allocated to default plan offerings that may not be in line with the investor's desired risk or return.

Due to the cumbersome nature of rolling over investments from one plan to another, and the fear of selling low in one plan and buying high in another, investors tend to either leave their funds in a former employer's plan or roll their funds into a money market fund or guaranteed investment contract (GIC) fund, as these types of funds are viewed as “safe havens.” If the investor decides to leave their funds in a former employer's plan, the investor will be required to manage two investment portfolios with different investment offerings, one in the new employer's plan and one in the former employer's plan. On the other hand, if the investor rolls the funds into the new employer's plan, and allocates the funds to a money market fund or GIC for an extended period of time, the investor's return will be negatively impacted if the funds could have been allocated to a fund that was more in line with their risk and return objectives.

### SUMMARY OF THE INVENTION

The present invention provides a method and a system for guaranteeing a specified return on funds transferred, or rolled over into, a qualified plan for a specified period of time by paying out the differential between the participant's calculated actual return over the specified term and the specified guaranteed return. This invention addresses the anxiety an investor experiences when rolling over funds from one qualified plan or IRA to another by establishing a guaranteed return on the investor's rollover funds for a specified period of time, and paying out the difference between the investor's calculated actual return and the guaranteed rate of return.

The method comprises:
a. Establishing a record of the plan participant and initial amount of rollover into the qualified plan (RBEG).
b. Establishing a record of the guaranteed return basis (RETB). (Ex. S&P 500 Index Return)
c. Establishing a record of the specified term (TERM).
d. Establishing a record of the index value at beginning of the TERM (INDBEG)
e. Establishing a record of the amount of rollover source funds, plus earnings thereon, as of the end of the specified period (REND).
f. Establishing a record of the index value at the end of the TERM (INDEND).
g. Computing the actual rate of return on rollover source funds over the specified period (RETURN) based on the formula: ((REND−RBEG)/RBEG).
h. Computing the guaranteed rate of return (GRETURN) based on the RETB by subtracting the index value at the beginning of the TERM (INDBEG) from the index value at the end of the TERM (INDEND) and dividing the result by the index value at the beginning of the TERM (INDBEG). The simplified formula for computing the guaranteed rate of return is stated as ((INDEND−INDBEG)/INDBEG).
i. Computing the difference between the RETURN and GRETURN (VAR) based on the formula: RETURN−GRETURN.
j. Computing the dollar amount of payment (PAYMENT) related to guaranteeing return on rollover source funds based on the following:
   If the VAR is positive, the PAYMENT is zero.
   If the VAR is negative, the PAYMENT is calculated based on the following formula: ((VAR)×(−1))×RBEG.
k. Generating a report (REPORT) detailing participant data, RBEG, RETB, TERM, REND, RETURN, GRETURN, VAR, and PAYMENT.
l. Utilization of REPORT by guarantor to make payment to individual participant account.

### Utility

The present invention, also referred to as the Rollover Guarantee System (RGS), is useful to plan participants (investors), plan sponsors, and the RGS provider.

### Utility to Plan Participant

The main benefit of the present invention is that it provides the participant with time to evaluate plan offerings and determine the appropriate mapping of investments between plans. For example, if an investor is considering rolling funds into a new employer's 401(k) plan he/she may not consider the fund presented as the new plan's “Blue Chip Growth Fund” an equivalent offering to the “Blue Chip Growth Fund” in his/her prior employer's plan. The invention relieves some of the anxiety related to initial mapping decisions by guaranteeing a specified rate of return for a short-term period, which allows the investor to first make initial mapping decisions and then adjust these initial decisions over the course of the specified term with the knowledge that the return on their rolled over funds will not fall below the guaranteed rate of return.

In addition, participants will be more comfortable and confident with rollovers through the use of the present invention, which will reduce the average time between an employer change and a rollover into the new employer's plan. This will result in the additional benefit of a reduction in time required to manage a portfolio in two different plans with two different menus of investment offerings.

The present invention will also generally provide an investor with a guaranteed return that is greater than the guaranteed return provided by a money market fund or a GIC. This is significant because money market funds and GIC's are seen as low risk “safe havens” for funds rolled into a plan; however, holding a significant portion of a portfolio in these type of investments can result in returns that fall short of investor expectations and goals. The present invention allows the investor to pursue funds that offer greater return potential than money market funds or GIC's, while at the same time guaranteeing a return on rolled funds that is in excess of returns generally provided by money market funds or GIC's.

### Utility to Plan Sponsor

The present invention will also benefit the plan sponsor in several ways through encouraging employees to roll funds from their previous employer's plan into their current employer's plan. For example, since many plan fees are spread ratably over all participants in a plan, over time the expense allocation on a per participant basis can be lowered by an increase in plan investments through rollovers into the plan. This ability to impact the plan's expense allocation through encouraging rollovers into the plan is a useful tool for plan sponsors that are active in managing plan expense ratios, and are conscientious of the fact that plan expenses can significantly impact participant returns. Furthermore, this reduction in expense allocation on a per participant basis is also a direct benefit to the participant not previously noted above.

In addition to the reduction in individual participant expense allocations, the plan sponsor will also benefit from the reduction in the total effective plan administration fee percentage, as in many cases plan administrative fees are based on a regressive schedule, charging less for plan assets over a certain level (ex. an annual fee of 50 basis points (bps) on the first $10 million in plan assets, and 35 bps on plan assets greater than $10 million).

The present invention will also reduce the average time between an employer change and a rollover into the new employer's (plan sponsor's) plan. This reduction in time benefits the new plan sponsor by accelerating the expense reduction benefits noted above, and also by reducing the amount that current employees subsidize the administrative fees of the plans of former employers, who may be direct competitors, by maintaining plan balances in plans of former employers.

### Utility to RGS (Present Invention) Provider

Inherent in utilizing the present invention is the demonstration of the ability to understand the complexities involved with the decision to roll over funds from one plan into another. Furthermore, the invention provides a unique opportunity to the provider to address the significant concern of participants considering a rollover that they may be selling low and buying high when they roll over funds from one plan to another.

From a pricing standpoint, the invention allows the provider to build the fee structure (ex. initial fixed fee plus additional amount based on amount of funds rolled into the plan) to fit the specific guaranteed return. For example, if the provider guarantees a return based on the S&P 500 Index, the provider can determine the cost to hedge the risk borne by the provider required to guarantee a return tied to the S&P index, and build in an additional margin on top of the cost to hedge. The cost of hedging would be based on the cost of the instruments required (ex. options, index positions, cost of funds if borrowing is necessary) to limit the exposure of the provider. The provider can also limit exposure by establishing a collar on the amount of participant funds invested in individual directed accounts, or other funds that are negatively correlated with the index the guaranteed return is based upon, that will qualify to be covered by the present invention. Furthermore, the provider can limit overall exposure, rather than exposure to a specific fund or type of fund, by limiting the differential payout to a percentage of the funds rolled over (ex. a maximum differential payout of 10% of rolled over funds). These types of adjustments to the terms will allow the provider to offer different levels of coverage at different fee structure levels.

In addition to the benefits described above, the provider will be encouraging the rollover of participant funds into the plans currently under the provider's administrative platform, as well as attracting new plans that are interested in the benefits of the invention. By encouraging rollovers, the provider will experience the acceleration of participant rollovers into the plans under its management, which will lead to an increase in assets on an individual plan basis, and an increase in the overall assets under management by the provider. This overall increase in assets under management will drive a significant increase in administrative fee income for the provider.

### BRIEF DESCRIPTION OF THE DRAWINGS

FIG. 1 is an operational flow chart presenting the method and system of the invention.

FIG. 2 is an operational flow chart depicting the utilization of the invention.

### DETAILED DESCRIPTION OF THE INVENTION

Before the present invention is described, it is to be understood that this invention is not limited to the embodiments described. It is also to be understood that the terminology used herein is for the purpose of describing such embodiments, and is not intended to be limiting, as the scope of the present invention will be limited only by the appended claims.

### DEFINITIONS

Guaranteed Return Basis

As used herein, the term “guaranteed return basis” comprises any one or a combination of the following:
a. S&P 500 Index
b. S&P 100 Index
c. S&P 600 Index
d. S&P Comp1500
e. S&P Mid Cap 400 Index
f. Dow Jones Industrial Average
g. Dow Jones Composite Average
h. Dow Jones Transportation Average
i. Dow Jones Utility Average
j. NYSE Composite (DJ)
k. NYSE Intl 100 Index
l. NYSE TMT Index
m. NYSE US 100 Index
n. NYSE World Leaders Index
o. NASDAQ Bank
p. NASDAQ Biotechnology
q. NASDAQ Composite
r. NASDAQ Computer
s. NASDAQ Financial 100
t. NASDAQ Industrial
u. NASDAQ Insurance
v. NASDAQ Other Finance
w. NASDAQ Telecommunications
x. NASDAQ Transportation
y. NASDAQ-100
z. BATS 1000 Index
aa. DJUS Market Index (full-cap)
bb. NYSE Amex Composite Index
cc. NYSE ARCA Major Market Index
dd. NYSE ARCA Networking Index
ee. NYSE Arca Tech 100 Index
ff. PHLX Semiconductor
gg. Russell 1000
hh. Russell 2000
ii. Russell 3000
jj. 13-Week Treasury Bill
kk. CBOE Interest Rate 10-Year T-No
ll. Treasury Yield 30 Years
mm. Treasury Yield 5 Years
nn. An exchange traded fund with its value derived from any of the aforementioned indices.
oo. A mutual fund with its value derived from any of the aforementioned indices.
pp. An index or other financial measure that has not been included in the
aforementioned indices.
qq. A specifically stated percentage return that is independent of any other index or
financial measure.

### Rollover Guarantee System Provider

As used herein, the term “Rollover Guarantee System provider,” also referred to as “provider” or “RGS provider,” shall refer to the individual or entity providing the method or system for use in guaranteeing a specified return on funds transferred, or rolled over into, a qualified plan for a specified period of time by paying out, in the form of a payment to the participant's account, the differential between the participant's calculated actual return over the specified term and the specified guaranteed return.

The Invention in Greater Detail

The present invention provides a method and a system for guaranteeing a specified return on funds transferred, or rolled over into, a qualified plan for a specified period of time by paying out, in the form of a payment to the participant's account, the differential between the participant's calculated actual return over the specified term and the specified guaranteed return.

The present invention comprises a computer having a memory with associated data input/output and processing means for establishing a record of the plan participant, establishing a record of the initial rollover amount, establishing a record of the guaranteed return basis, establishing a record of the specified term, establishing a record of the index value at the beginning of the specified term, establishing a record of the rollover source funds at the end of the specified term including all earnings thereon, establishing a record of the index value at the end of the specified term, and utilizing the established records to calculate a payment amount at the end of the specified term computed by multiplying the percentage shortfall between the guaranteed return over the specified period and the calculated actual return by the rollover amount at the beginning of the period.

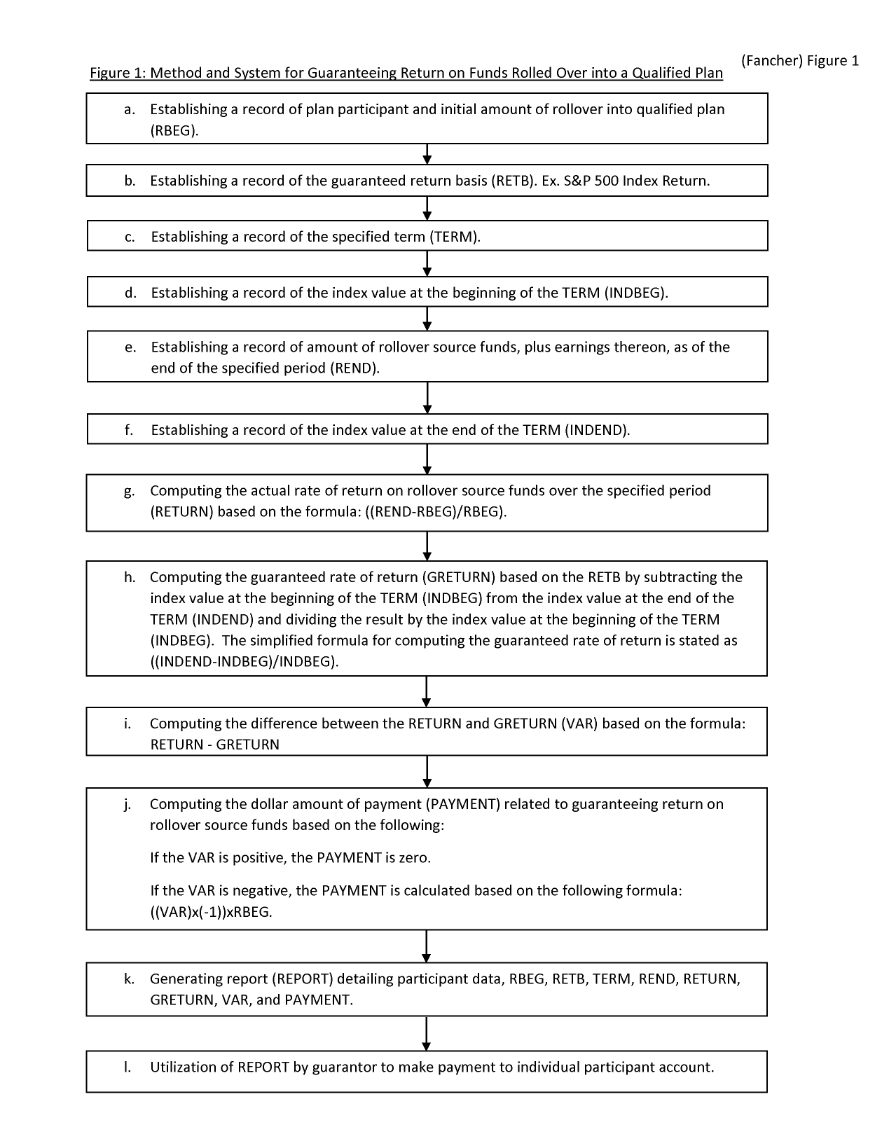

Referring now to FIG. 1, wherein steps appearing in boxes with letter designations corresponding to the steps presented below, the method comprises:
a. Establishing a record of the plan participant and initial amount of rollover into the qualified plan (RBEG).
b. Establishing a record of the guaranteed return basis (RETB). (Ex. S&P 500 Index Return)
c. Establishing a record of the specified term (TERM).
d. Establishing a record of the index value at the beginning of the TERM (INDBEG).
e. Establishing a record of the amount of rollover source funds, plus earnings thereon, as of the end of the specified period (REND).
f. Establishing a record of the index value at the end of the TERM (INDEND).
g. Computing the actual rate of return on rollover source funds over the specified period (RETURN) based on the formula: ((REND−RBEG)/RBEG).
h. Computing the guaranteed rate of return (GRETURN) based on the RETB by subtracting the index value at the beginning of the TERM (INDBEG) from the index value at the end of the TERM (INDEND) and dividing the result by the index value at the beginning of the TERM (INDBEG). The simplified formula for computing the guaranteed rate of return is stated as ((INDEND−INDBEG)/INDBEG).
i. Computing the difference between the RETURN and GRETURN (VAR) based on the formula: RETURN−GRETURN.
j. Computing the dollar amount of payment (PAYMENT) related to guaranteeing return on rollover source funds based on the following:
   If the VAR is positive, the PAYMENT is zero.
   If the VAR is negative, the PAYMENT is calculated based on the following formula: ((VAR)×(−1))×RBEG.
k. Generating a report (REPORT) detailing participant data, RBEG, RETB, TERM, REND, RETURN, GRETURN, VAR, and PAYMENT.
l. Utilization of REPORT by guarantor to make payment to individual participant account.

In a first exemplary embodiment of the invention, a plan participant rolls over an amount of $50,000 into a qualified plan that is covered by the Rollover Guarantee System, with a guaranteed return basis of the S&P 500 Index over the specified term of 3 months, and the rollover source funds plus earnings thereon at the end of the specified term of 3 months equals $52,500.

If the S&P Index was 1,600 at the beginning of the specified the 3 month term and 1,720 at the end of the specified term, the method and system would calculate the payment amount to the individual participant account as follows:

Compute the actual return on rollover source funds over the specified term:

((REND−RBEG)/RBEG)=RETURN

(($52,500−$50,000)/$50,000)=0.05=5%

Compute the guaranteed rate of return based on the return basis:

((INDEND−INDBEG)/INDBEG)=GRETURN

((1,720−1,600)/1,600)=0.075=7.5%

Compute the difference between the actual return and guaranteed return:

RETURN−GRETURN=VAR

0.05−0.075=−0.025=−2.5%

Compute the dollar amount of payment to individual participant account:
Since VAR is negative, the payment amount to the individual participant account is equal to:

((VAR)×(−1))×RBEG=PAYMENT

((−0.025)×(−1))×$50,00$1,250

In a second exemplary embodiment of the invention, a plan participant rolls over an amount of $50,000 into a qualified plan that is covered by the Rollover Guarantee System, with a guaranteed return basis of the S&P 500 Index over the specified term of 3 months, and the rollover source funds plus earnings thereon at the end of the specified term of 3 months equals $52,500.

If the S&P Index was 1,600 at the beginning of the specified the 3 month term and 1,664 at the end of the specified term, the method and system would calculate the payment amount to the individual participant account as follows:

Compute the actual return on rollover source funds over the specified term:

((REND−RBEG)/RBEG)=RETURN

(($52,500−$50,000)/$50,000)=0.05=5%

Compute the guaranteed rate of return based on the return basis:

((INDEND−INDBEG)/INDBEG)=GRETURN

((1,664−1,600)/1,600)=0.04=4%

Compute the difference between the actual return and guaranteed return:

RETURN−GRETURN=VAR

0.05−0.04=0.01=1%

Compute the dollar amount of payment to individual participant account:
Since VAR is positive, the payment amount to the individual participant account is equal to zero.

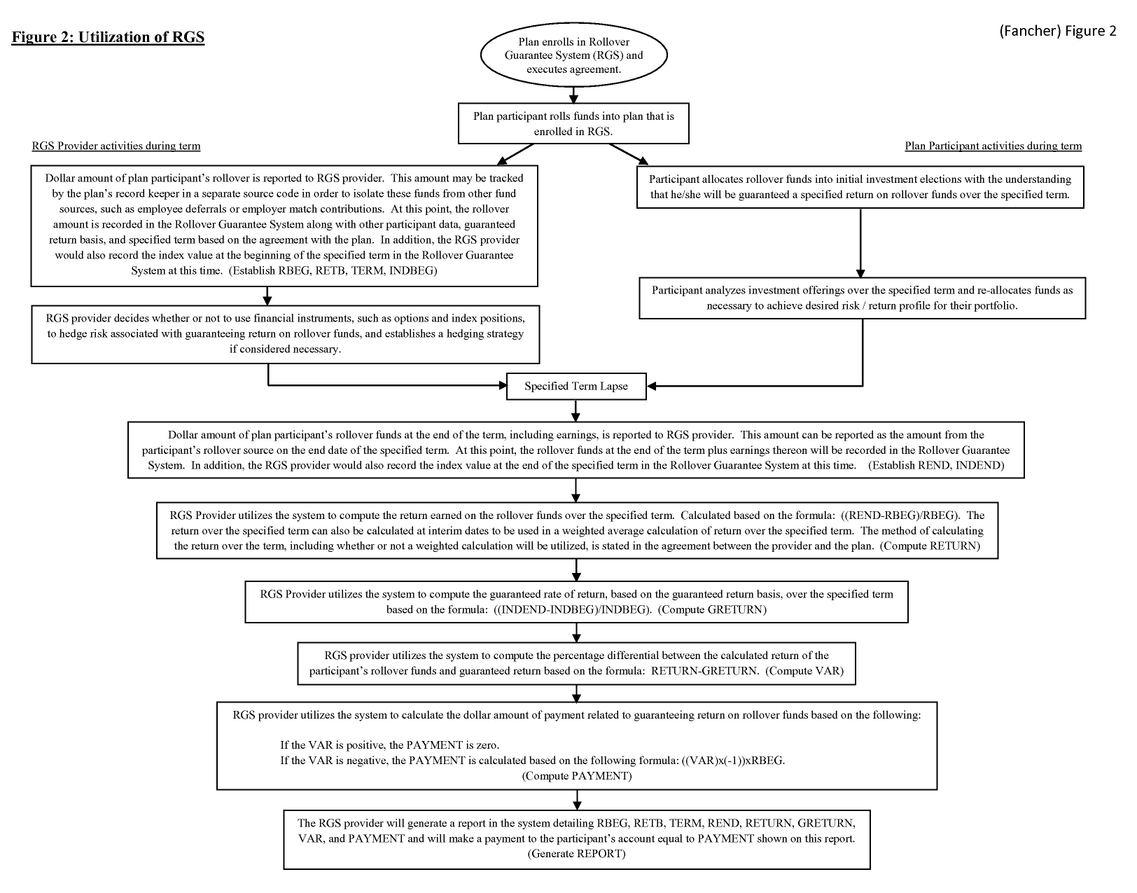

Operationally, the Rollover Guarantee System provider would set up and operate the invention as depicted in FIG. 2 and as follows:

First, the Rollover Guarantee System provider enters into an agreement with the qualified plan detailing the specific terms including fee structure, guarantee return basis, specified term of guarantee, limitations on guarantee, and any specific investment selections within the plan that would be excluded from the rollover guarantee. Prior to drafting the agreement, the rollover guarantee service provider would analyze plan investments to determine if any plan investments should be excluded from the rollover guarantee. For example, the agreement could state that the Rollover Guarantee System will be utilized to guarantee all rollovers into ABC 401(k) Plan in the year 20XX for a stated $5,000 fee, with a guarantee return basis of the S&P 500 Index, a 3 month specified term that begins on the date of rollover into the plan, and a maximum payment of 10% of rollover source funds related to the rollover guarantee. The agreement can also specify whether the Rollover Guarantee System will be utilized for all participants in the plan, or if the participants will be required to elect to participate in order to be included in the Rollover Guarantee System.

Next, a plan participant rolls funds over from another qualified plan into the plan covered by the Rollover Guarantee System.

At the point of the rollover into the qualified plan, the rollover is reported to the Rollover Guarantee System provider to initially be recorded within the Rollover Guarantee System. This establishes the participant record related to the initial rollover source funds to later be used in the calculation of the actual return on these rollover source funds and determining whether or not there will be a payment related to guaranteeing a return on these rollover source funds. The provider will also record the guaranteed return basis and specified term in the system based on the Rollover Guarantee System agreement with the plan at this time. Once the guaranteed return basis is established, the provider will also establish the record of the index value at the beginning of the specified term within the system. In addition, once the provider has recorded the initial rollover amount, the decision with regard to whether or not a hedging strategy should be established to limit the exposure to the provider will be made. Furthermore, the provider can request interim updates of rollover source funds and earnings thereon in order to track the performance of the rollover source funds throughout the specified term.

The rollover of funds into the qualified plan also marks the beginning of the plan participant's activities during the specified term of the agreement. The participant will make initial allocation decisions with the understanding that he/she will be guaranteed a specified return on rollover source funds for the specified term, and throughout the specified term the participant will continue to analyze the plan's investment offerings and make re-allocations in order to achieve the desired risk and return profile for their portfolio.

After the specified term of the rollover guarantee agreement expires, the plan participant's rollover source funds plus earnings thereon at the end of the specified term will be reported to the Rollover Guarantee System provider and recorded within the Rollover Guarantee System. This establishes the record of rollover source funds plus earnings thereon at the end of the specified period to be used in the calculation of the actual return on rollover source funds and determining whether or not there will be a payment related to guaranteeing a return on these rollover source funds. At this time, the provider will also establish a record of the index value at the end of the term within the system.

Once the provider has established a participant record, including the initial amount of rollover source funds, specified term, guaranteed return basis, and the amount of rollover source funds plus earnings thereon at the end of the specified term, the provider will utilize the system to compute the actual return on rollover source funds over the specified term based on the following formula:

((REND−RBEG)/RBEG)

Next, the provider will utilize the system to compute the guaranteed rate of return based on the guaranteed return basis established in the rollover guarantee system agreement based on the following formula:

((INDEND−INDBEG)/INDBEG)

Once the actual return on rollover source funds and the guaranteed rate of return are computed, the provider will utilize the system to compute the difference between the actual rate of return on rollover source funds and the guaranteed rate of return on rollover source funds based on the following formula:

RETURN−GRETURN

Once the difference between the actual rate of return on rollover source funds and the guaranteed rate of return is known, the provider will utilize the system to compute the dollar amount of payment, if any, related to guaranteeing the return on rollover source funds based on the following formula:
If the VAR is positive, the PAYMENT is zero.
If the VAR is negative, the PAYMENT is calculated based on the following formula: ((VAR)×(−1))×RBEG.

Finally, the provider will utilize the system to generate a report detailing the participant record including participant data, rollover source funds at the beginning of the specified term, the guaranteed return basis, the specified term, rollover source funds plus earnings thereon at the end of the specified term, the calculated actual return on rollover source funds, the calculated guaranteed return for the specified period, the difference between the calculated actual return and the guaranteed return, and the payment amount related to guaranteeing the return on rollover source funds. This report will be utilized by the provider to make the payment related to guaranteeing the return on rollover source funds to the individual participant account within the qualified plan.

While the present invention has been illustrated in detail by description of embodiments, it is not the applicant's intention to restrict or in any way limit the scope of the appended claims. Additional advantages and modifications will appear to those skilled in the art. The invention in its broader aspects is therefore not limited to the details and illustrative examples described. Accordingly, departures may be made from such illustrations without departing from the spirit or scope of the applicant's general inventive concept.

I claim:

1. A method for guaranteeing a specified return on funds transferred, or rolled over into, a qualified plan for a specified period of time by making a payment to the individual participant account within a qualified plan equal to the dollar value of the differential between the calculated actual return on rollover source funds over the specified term and the specified guaranteed return comprising:
Providing a computer having a memory with associated data input/output and processing means for establishing a record of the plan participant, establishing a record of the initial rollover amount, establishing a record of the guaranteed return basis, establishing a record of the specified term, establishing a record of the index value at the beginning of the specified term, establishing a record of the rollover source funds at the end of the specified term including all earnings thereon, establishing a record of the index value at the end of the specified term, and utilizing the established records to calculate a payment amount at the end of the specified term according to the following equation:
If VAR, representing the calculated actual return on rollover source funds less the specified guaranteed return, is equal to or greater than zero, then PAYMENT, representing the payment to be made to the participant's (investor's) account, is equal to zero. If VAR is less than zero, compute ((VAR)×(−1))×RBEG for PAYMENT, where RBEG represents the participant's initial amount of rollover into the plan.

2. The method according to claim 1, wherein the qualified plan is a 401(k) Plan.

3. The method according to claim 1, wherein the qualified plan is a 403(b) Plan.

4. The method according to claim 1, wherein the qualified plan is a 457 Plan.

5. The method according to claim 1, wherein the qualified plan is a traditional Individual Retirement Account.

6. The method according to claim 1, wherein the qualified plan is a Roth IRA.

7. The method according to claim 1, wherein the qualified plan is a SIMPLE IRA.

8. The method according to claim 1, wherein the qualified plan is a Spousal IRA.

9. The method according to claim 1, wherein the qualified plan is a Group IRA.

10. The method according to claim 1, wherein the qualified plan is an Education IRA.

11. The method according to claim 1, wherein the qualified plan is an SEP IRA.

12. The method according to claim 1, wherein the qualified plan is a Keogh Plan.

13. The method according to claim 1, wherein the qualified plan is an Employee Stock Ownership Plan (ESOP).

14. The method according to claim 1, wherein the qualified plan is an individual retirement or education account.

15. The method according to claim 1, wherein the guaranteed return is based on an index, or combination of indices, from the group consisting of:
a. S&P 500 Index
b. S&P 100 Index
c. S&P 600 Index
d. S&P Comp1500
e. S&P Mid Cap 400 Index
f. Dow Jones Industrial Average
g. Dow Jones Composite Average
h. Dow Jones Transportation Average
i. Dow Jones Utility Average
j. NYSE Composite (DJ)
k. NYSE Intl 100 Index
l. NYSE TMT Index
m. NYSE US 100 Index
n. NYSE World Leaders Index
o. NASDAQ Bank
p. NASDAQ Biotechnology
q. NASDAQ Composite
r. NASDAQ Computer
s. NASDAQ Financial 100
t. NASDAQ Industrial
u. NASDAQ Insurance
v. NASDAQ Other Finance
w. NASDAQ Telecommunications
x. NASDAQ Transportation
y. NASDAQ-100
z. BATS 1000 Index
aa. DJUS Market Index (full-cap)
bb. NYSE Amex Composite Index
cc. NYSE ARCA Major Market Index
dd. NYSE ARCA Networking Index
ee. NYSE Arca Tech 100 Index
ff. PHLX Semiconductor
gg. Russell 1000
hh. Russell 2000
ii. Russell 3000
jj. 13-Week Treasury Bill
kk. CBOE Interest Rate 10-Year T-No
ll. Treasury Yield 30 Years
mm. Treasury Yield 5 Years
nn. An exchange traded fund with its value derived from any of the aforementioned indices.
oo. A mutual fund with its value derived from any of the aforementioned indices.
pp. An index or other financial measure that has not been included in the aforementioned indices.
qq. A specifically stated percentage return that is independent of any other index or financial measure.

16. The method of claim 1 comprising:
a. Establishing a record of the plan participant and initial amount of rollover into the qualified plan (RBEG).
b. Establishing a record of the guaranteed return basis (RETB). (Ex. S&P 500 Index Return)
c. Establishing a record of the specified term (TERM).
d. Establishing a record of the index value at the beginning of the TERM (INDBEG).
e. Establishing a record of the amount of rollover source funds, plus earnings thereon, as of the end of the specified period (REND).
f. Establishing a record of the index value at the end of the TERM (INDEND).
g. Computing the actual rate of return on rollover source funds over the specified period (RETURN) based on the formula: ((REND−RBEG)/RBEG).
h. Computing the guaranteed rate of return (GRETURN) based on the RETB by subtracting the index value at the beginning of the TERM (INDBEG) from the index value at the end of the TERM (INDEND) and dividing the result by the index value at the beginning of the TERM (INDBEG). The simplified formula for computing the guaranteed rate of return is stated as (INDEND−INDBEG)/INDBEG).
i. Computing the difference between the RETURN and GRETURN (VAR) based on the formula: RETURN−GRETURN.
j. Computing the dollar amount of payment (PAYMENT) related to guaranteeing return on rollover source funds based on the following:
If the VAR is positive, the PAYMENT is zero.
If the VAR is negative, the PAYMENT is calculated based on the following formula: ((VAR)×(−1))×RBEG.
k. Generating a report (REPORT) detailing participant data, RBEG, RETB, TERM, REND, RETURN, GRETURN, VAR, and PAYMENT.
l. Utilization of REPORT by guarantor to make payment to individual participant account.

17. A system for guaranteeing a specified return on funds transferred, or rolled over into, a qualified plan for a specified period of time by making a payment to the individual participant account within a qualified plan equal to the dollar value of the differential between the calculated actual return on rollover source funds over the specified term and the specified guaranteed return comprising:
Providing a computer having a memory with associated data input/output and processing means for establishing a record of the plan participant, establishing a record of the initial rollover amount, establishing a record of the guaranteed return basis, establishing a record of the specified term, establishing a record of the index value at the beginning of the specified term, establishing a record of the rollover source funds at the end of the specified term including all earnings thereon, establishing a record of the index value at the end of the specified term, and utilizing the established records to calculate a payment amount at the end of the specified term according to the following equation:
If VAR, representing the calculated actual return on rollover source funds less the specified guaranteed return, is equal to or greater than zero, then PAYMENT, representing the payment to be made to the participant's (investor's) account, is equal to zero. If VAR is less than zero, compute ((VAR)×(−1))×RBEG for PAYMENT, where RBEG represents the participant's initial amount of rollover into the plan.

18. The system according to claim 17, wherein the qualified plan is a 401(k) Plan.

19. The system according to claim 17, wherein the qualified plan is a 403(b) Plan.

20. The system according to claim 17, wherein the qualified plan is a 457 Plan.

21. The system according to claim 17, wherein the qualified plan is a traditional Individual Retirement Account.

22. The system according to claim 17, wherein the qualified plan is a Roth IRA.

23. The system according to claim 17, wherein the qualified plan is a SIMPLE IRA.

24. The system according to claim 17, wherein the qualified plan is a Spousal IRA.

25. The system according to claim 17, wherein the qualified plan is a Group IRA.

26. The system according to claim 17, wherein the qualified plan is an Education IRA.

27. The system according to claim 17, wherein the qualified plan is an SEP IRA.

28. The system according to claim 17, wherein the qualified plan is a Keogh Plan.

29. The system according to claim 17, wherein the qualified plan is an Employee Stock Ownership Plan (ESOP).

30. The system according to claim 17, wherein the qualified plan is an individual retirement or education account.

31. The system according to claim 17, wherein the guaranteed return is based on an index, or combination of indices, from the group consisting of:
a. S&P 500 Index
b. S&P 100 Index
c. S&P 600 Index
d. S&P Comp1500
e. S&P Mid Cap 400 Index
f. Dow Jones Industrial Average
g. Dow Jones Composite Average
h. Dow Jones Transportation Average
i. Dow Jones Utility Average
j. NYSE Composite (DJ)
k. NYSE Intl 100 Index
l. NYSE TMT Index
m. NYSE US 100 Index
n. NYSE World Leaders Index
o. NASDAQ Bank
p. NASDAQ Biotechnology
q. NASDAQ Composite
r. NASDAQ Computer
s. NASDAQ Financial 100
t. NASDAQ Industrial
u. NASDAQ Insurance
v. NASDAQ Other Finance
w. NASDAQ Telecommunications
x. NASDAQ Transportation
y. NASDAQ-100
z. BATS 1000 Index
aa. DJUS Market Index (full-cap)
bb. NYSE Amex Composite Index
cc. NYSE ARCA Major Market Index
dd. NYSE ARCA Networking Index
ee. NYSE Arca Tech 100 Index
ff. PHLX Semiconductor
gg. Russell 1000
hh. Russell 2000
ii. Russell 3000
jj. 13-Week Treasury Bill
kk. CBOE Interest Rate 10-Year T-No
ll. Treasury Yield 30 Years
mm. Treasury Yield 5 Years
nn. An exchange traded fund with its value derived from any of the aforementioned indices.
oo. A mutual fund with its value derived from any of the aforementioned indices.
pp. An index or other financial measure that has not been included in the aforementioned indices.
qq. A specifically stated percentage return that is independent of any other index or financial measure.

32. The system of claim 17 comprising:
wherein the processing means establishes a record of the plan participant and initial amount of rollover into the qualified plan (RBEG).
wherein the processing means establishes a record of the guaranteed return basis (RETB). (Ex. S&P 500 Index Return)
wherein the processing means establishes a record of the specified term (TERM),
wherein the processing means establishes record of the index value at the beginning of the TERM (INDBEG).
wherein the processing means establishes a record of the amount of rollover source funds, plus earnings thereon, as of the end of the specified period (REND).
wherein the processing means establishes record of the index value at the end of the TERM (INDEND).
wherein the processing means computes the actual rate of return on rollover source funds over the specified period (RETURN) based on the formula: ((REND−RBEG)/RBEG).
wherein the processing means computes the guaranteed rate of return (GRETURN) based on the RETB by subtracting the index value at the beginning of the TERM (INDBEG) from the index value at the end of the TERM (INDEND) and dividing the result by the index value at the beginning of the TERM (INDBEG). The simplified formula for computation of the guaranteed rate of return stated as ((INDEND−INDBEG)/INDBEG).
wherein the processing means computes the difference between the RETURN and GRETURN (VAR) based on the formula: RETURN−GRETURN. wherein the processing means computes the dollar amount of payment (PAYMENT) related to guaranteeing return on rollover source funds based on the following:
If the VAR is positive, the PAYMENT is zero.
If the VAR is negative, the PAYMENT is calculated based on the following formula: ((VAR)×(−1))×RBEG.
wherein the processing means generates a report (REPORT) detailing participant data, RBEG, RETB, TERM, REND, RETURN, GRETURN, VAR, and PAYMENT.
wherein the guarantor utilizes the REPORT to make payment to individual participant account.
